(19) United States
(12) Patent Application Publication
(10) Pub. No.: US 2021/0255211 A1
(43) Pub. Date: Aug. 19, 2021

(54) METHOD AND APPARATUS FOR SENSOR ORIENTATION DETERMINATION

(71) Applicant: NOKIA TECHNOLOGIES OY, Espoo (FI)

(72) Inventors: Péter SZILÁGYI, Budapest (HU); Csaba VULKÁN, Budapest (HU); Joachim WUILMET, Dubai (AE); Ashish TANDON, Dubai (AE); Zoltán LÁZÁR, Budapest (HU); Ali SHARAF, Budapest (HU)

(21) Appl. No.: 17/255,749

(22) PCT Filed: Jul. 3, 2018
(86) PCT No.: PCT/EP2018/067935

§ 371 Date: Dec. 23, 2020

(51) Int. Cl. G01P 13/00; G01C 21/16; G01C 21/26

(52) U.S. Cl. CPC G01P 13/00; G01C 21/26; G01C 21/16

(57) ABSTRACT

Some embodiments include a method and apparatus which obtains sensor data associated with a vehicle. The sensor data includes three-dimensional acceleration data and three-dimensional rotation data, with respect to a sensor coordinate system. A gravity vector is obtained, and it is determined when the vehicle starts moving. Acceleration direction is used as a forward direction of the vehicle. It is determined from the rotation data when the vehicle changes direction, the rotation data indicating two different directions. The gravity vector is used to distinguish which is an upward direction by selecting directions the direction which has larger angle with respect to the gravity vector as the upward direction. The forward direction and upward direction are used to determine a rightward direction. The forward direction, upward direction and rightward direction represent the vehicle coordinate system. The orientation of the apparatus with respect to the orientation of the vehicle is determined.

### TECHNICAL FIELD

The present invention relates to a method for sensor orientation determination in a vehicle, an apparatus for sensor orientation determination in a vehicle and a computer code for sensor orientation determination.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Understanding the motion pattern of vehicles may provide insight useful for tracking, controlling or detecting anomalies in the behaviour of the vehicles (including both machinery as well as driver behaviour). One approach to motion analytics is to collect and process data from motion sensors residing in the monitored vehicles. Vehicles may cover a wide range of machines including passenger cars, taxies, trucks, busses, trams, trains, vessels, boats, ships, bicycles, motorbikes, etc. When applied specifically to cars or trucks (i.e., manned automobiles), analysing the behaviour and attitude of drivers reflected in the vehicular motion sensor data may enable numerous use cases including increase of general road safety, personalizing driver assistance solutions or insight-based insurance models.

Motion sensors are nowadays commonly available in small form factor using micro-electrical-mechanical system (MEMS) technology, which enables their integration into many electrical products and devices such as smartphones, wearable devices or even directly to vehicles. Usually the platform or operating system running on such devices provides access to the sensor data via an application programming interface (API) that provides the accelerometer and gyroscope data in 3D vector format with components corresponding to the acceleration or rotation along/around the X, Y and Z axes. These axes define the sensor's 3D coordinate system, meaning that any motion sensor data is to be interpreted relative to the physical orientation of the sensor (or its enclosing device) itself.

Accelerometer data combined with GPS (Global Positioning System) speed/direction information and possibly with additional magnetic sensors to figure out the vehicle's forward direction may not be useful in many situations due to, for example, that the GPS may have low temporal resolution (new location samples can be obtained fairly rarely, e.g. in every few seconds) and its inaccuracy especially in urban canyons, tunnels and dense areas, where sometimes GPS may even report change of location where in fact the vehicle is still, or the reported location may be a few building blocks or street corners away from the real location. Additionally, a GPS receiver may consume much more electrical power than an accelerometer (the power consumption may even be 10-fold compared to the accelerometer), which may be problematic in case of battery powered sensor devices such as a smartphone. The magnetic sensors are not accurate either due to the local variations in the Earth's magnetic field as well as the distortion effect of electrical current generated in the proximity the sensor. Electrical cars are especially problematic, but a nearby tram, train or electrical wires may also create significant perturbances in the magnetic field that makes compasses unreliable.

### SUMMARY

Various embodiments provide a method, apparatus and computer code for sensor orientation determination in a vehicle.

Various aspects of examples of the invention are provided in the detailed description.

According to a first aspect, there is provided an apparatus comprising means for:

obtaining sensor data from at least one motion sensor associated with a vehicle, said motion sensor having a sensor coordinate system and said vehicle having a vehicle coordinate system, said sensor data comprising three-dimensional acceleration data from an accelerometer and three-dimensional rotation data from a gyroscope with respect to a sensor coordinate system;

obtaining a gravity vector;

determining from the acceleration data and rotation data when the vehicle starts moving in straight line;

when the determining indicated that the vehicle has started moving in straight line, using acceleration direction indicated by acceleration data as a forward direction of the vehicle;

determining from the rotation data when the vehicle changes direction, the rotation data indicating at least two different directions;

comparing the gravity vector with the at least two different directions;

selecting from the at least two different directions that direction which has the largest angle with respect to the gravity vector as the upward direction;

using the forward direction and upward direction to determine a rightward direction, said forward direction, upward direction and rightward direction representing the vehicle coordinate system; and

determining the orientation of the motion sensor with respect to the orientation of the vehicle from the vehicle coordinate system and the sensor coordinate system.

According to a second aspect, there is provided a method comprising:

obtaining sensor data from at least one motion sensor associated with a vehicle, said motion sensor having a sensor coordinate system and said vehicle having a vehicle coordinate system, said sensor data comprising three-dimensional acceleration data from an accelerometer and three-dimensional rotation data from a gyroscope with respect to a sensor coordinate system;

obtaining a gravity vector;

determining from the acceleration data and rotation data when the vehicle starts moving in straight line;

when the determining indicated that the vehicle has started moving in straight line, using acceleration direction indicated by acceleration data as a forward direction of the vehicle;

determining from the rotation data when the vehicle changes direction, the rotation data indicating at least two different directions;

comparing the gravity vector to distinguish from the at least two different directions;

selecting from the at least two different directions that direction which has the largest angle with respect to the gravity vector as the upward direction;

using the forward direction and upward direction to determine a rightward direction, said forward direction, upward direction and rightward direction representing the vehicle coordinate system; and

determining the orientation of the motion sensor with respect to the orientation of the vehicle from the vehicle coordinate system and the sensor coordinate system.

According to a third aspect, there is provided a system comprising at least:

a motions sensor associated with a vehicle, the apparatus comprising an accelerometer for generating three-dimensional acceleration data and a gyroscope for generating three-dimensional rotation data from movements of the vehicle, said motion sensor having a sensor coordinate system and said vehicle having a vehicle coordinate system;

a motion transformation appliance element comprising means for:

obtaining a gravity vector;

determining from the acceleration data and rotation data when the vehicle starts moving in straight line;

when the determining indicated that the vehicle has started moving in straight line, using acceleration direction indicated by acceleration data as a forward direction of the vehicle;

determining from the rotation data when the vehicle changes direction, the rotation data indicating at least two different directions;

comparing the gravity vector with the at least two different directions;

selecting from the at least two different directions that direction which has the largest angle with respect to the gravity vector as the upward direction;

using the forward direction and upward direction to determine a rightward direction, said forward direction, upward direction and rightward direction representing the vehicle coordinate system; and

determining the orientation of the motion sensor with respect to the orientation of the vehicle from the vehicle coordinate system and the sensor coordinate system.

According to a fourth aspect, there is provided a computer program product including one or more sequences of one or more instructions which, when executed by one or more processors, cause an apparatus to at least perform the following:

obtain sensor data from at least one motion sensor associated with a vehicle, said motion sensor having a sensor coordinate system and said vehicle having a vehicle coordinate system, said sensor data comprising three-dimensional acceleration data from an accelerometer and three-dimensional rotation data from a gyroscope with respect to a sensor coordinate system;

obtaining a gravity vector;

determining from the acceleration data and rotation data when the vehicle starts moving in straight line;

when the determining indicated that the vehicle has started moving in straight line, using acceleration direction indicated by acceleration data as a forward direction of the vehicle;

determining from the rotation data when the vehicle changes direction, the rotation data indicating at least two different directions;

comparing the gravity vector with the at least two different directions;

selecting from the at least two different directions that direction which has the largest angle with respect to the gravity vector as the upward direction;

using the forward direction and upward direction to determine a rightward direction, said forward direction, upward direction and rightward direction representing the vehicle coordinate system; and

determining the orientation of the motion sensor with respect to the orientation of the vehicle from the vehicle coordinate system and the sensor coordinate system.

### BRIEF DESCRIPTION OF THE DRAWINGS

For a more complete understanding of example embodiments of the present invention, reference is now made to the following descriptions taken in connection with the accompanying drawings in which:

FIG. 1a shows an example of a motion sensor and a three-dimensional coordinate system of the motion sensor;

FIG. 1b shows an example of a device comprising the motion sensor and a three-dimensional coordinate system of the device;

FIGS. 2a and 2b show an example of a coordinate system of a vehicle;

FIG. 3 illustrates an example situation in which a forward acceleration in the vehicle's coordinate system has an arbitrary representation in a sensor's coordinate system;

FIG. 4 illustrates the effect of different sensor orientation on the interpretability of rotations;

FIG. 5 shows a high-level architecture of the alignment of sensor data, in accordance with an embodiment;

FIG. 6 illustrates operation of a motion transformation appliance part, in accordance with an embodiment;

FIG. 7 illustrates operation of a motion analytics appliance part, in accordance with an embodiment;

FIGS. 8a to 8d show some possible deployments of the alignment of sensor data, in accordance with an embodiment;

FIG. 9 illustrates one example of a deployment option in mobile networks, in accordance with an embodiment;

FIG. 10 shows a high-level implementation of a motion transformation appliance part, in accordance with an embodiment;

FIG. 11 shows some details of a profiling phase, in accordance with an embodiment;

FIG. 12a shows some further details of a profiling phase, in accordance with an embodiment;

FIG. 12b shows some details of a method, in accordance with an embodiment;

FIG. 13 shows some details on a conversion phase, in accordance with an embodiment;

FIG. 14 shows examples of recognition of some basic driving manoeuvres;

FIG. 15 shows an example of recognition of a lane change manoeuvre;

FIG. 16 shows an example of recognition of road surface impact;

FIG. 17 depicts an example of an apparatus, in accordance with an embodiment;

FIG. 18 depicts as a flow diagram an example embodiment of the operation of the apparatus;

FIG. 19 shows a part of an exemplifying radio access network;

FIG. 20 shows a block diagram of an apparatus according to an example embodiment;

FIG. 21 shows an apparatus according to an example embodiment;

FIG. 22 shows an example of an arrangement for wireless communication comprising a plurality of apparatuses, networks and network elements; and

FIG. 23 illustrates an example of motion sensors attached with a register plate.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

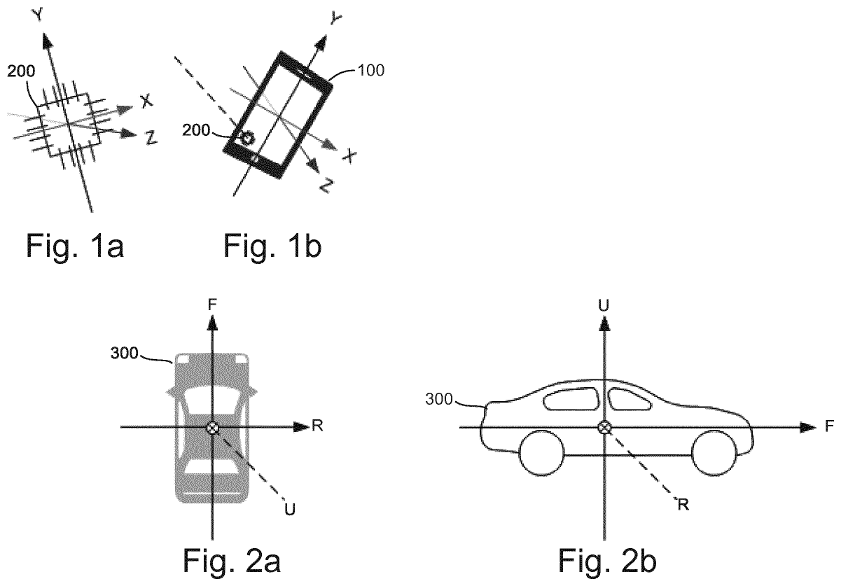

Accelerometers provide a three-dimensional vector reporting the acceleration [m/s2] measured along three orthogonal sensor axes (commonly denoted as X, Y, Z). Gyroscopes report the rotational speed components [rad/s] around the same sensor axes. Linear accelerometer is a variant of an accelerometer that excludes the force of gravity from its reported measurements. The sensor axes define a three-dimensional (3D) coordinate system relative to the sensor's physical orientation. Sensors may be installed in multi-purpose devices such as smartphones, in which case the sensor's coordinate system is aligned to the orientation of the enclosing device. An example of a 3D coordinate system of a sensor 200 is shown in FIG. 1a. FIG. 1b illustrates an example of a 3D coordinate system of an apparatus 100 comprising the sensor 200 of FIG. 1a.

In the following, accelerometers 202 and gyroscopes 204 are also called as motion sensors and a device which comprises at least one accelerometer and at least one gyroscope is also called as a motion sensor apparatus or a sensor apparatus 200.

Motion sensors mounted inside a vehicle can provide valuable information about the movements and manoeuvres of the vehicle, such as acceleration/brake, steering (left/right turn), lane changes, overtaking, etc. In order to intuitively understand movements of the vehicle, it may be described relative to a reference frame of the vehicle. For example, when a vehicle increases its speed through its engine, it is intuitively described as an acceleration vector pointing towards to front of the vehicle, regardless of the orientation of the vehicle in the world's coordinate system, to the magnetic North or to any other absolute reference system. Therefore, to describe and analyse motion of the vehicle and what it means from the driver's perspective, a coordinate system of the vehicle may be introduced, as shown in FIGS. 2a and 2b in accordance with an embodiment. The coordinate system of the vehicle is defined by three orthogonal axes, for example by creating a right-handed coordinate system in which the rightward R, forward F and upward U directions are defined relative to the physical frame of the vehicle. FIG. 2a is a top view showing a forward F and a rightward R coordinate direction of the vehicle 300. The upward U coordinate direction points towards the viewer. FIG. 2b is a side view showing the forward F and upward U coordinate direction of the vehicle 300. The rightward R coordinate direction points towards the viewer.

It may also be possible to create a left-handed coordinate system in which the leftward, forward and upward directions are defined relative to the physical frame of the vehicle 300.

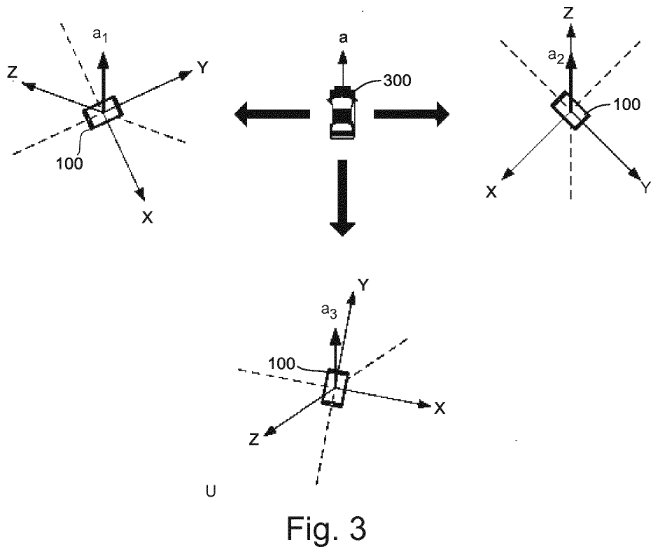

Measuring the vehicle's movements may require a motion sensor that is installed in the vehicle or brought onboard inside a device such as a smartphone. However, such motion sensor reports acceleration and rotation in the sensor's or device's own coordinate system, e.g. based on the X, Y and Z axes as shown in FIGS. 1a and 1b, that may not generally be aligned with the vehicle's rightward R, forward F and upward U coordinate system as shown in FIGS. 2a and 2b (i.e., axes in the two coordinate systems may not be pairwise parallel). Consequently, a forward acceleration a in the vehicle's coordinate system may have an arbitrary representation in the sensor's coordinate system, as shown in FIG. 3.

FIG. 3 illustrates three different example positions for the motion sensor device 100. A first example position is depicted on the left of the vehicle 300, a second example position is depicted on the right of the vehicle 300, and a third example position is depicted below the vehicle 300 in FIG. 3.

If the motion sensor 200, or the apparatus 100 comprising the motion sensor 200, is fixed (e.g., screw-mounted or embedded during manufacturing) inside the vehicle 300 in a known position, in principle the relative orientation of the sensor's and the vehicle's coordinate system could be measured offline and a rotation matrix specific to the vehicle-sensor pair could be calculated that transforms motion (acceleration/gyroscope) vectors from the sensor's coordinate system into the vehicle's coordinate system. Such measurement, if possible at all, would require a skilled manual measuring process and it would be still prone to errors in vehicle-sensor axis angle measurement precision. However, such measurements may not even be possible if the sensor is embedded deeply (inaccessibly) in the vehicle in an undocumented position, or it is not fixed/embedded inside the vehicle at all, e.g., a sensor is added as a part of a post-market installation or the sensor is within a device that is brought onboard the vehicle in an arbitrary position by e.g. a vehicle owner/driver/passenger.

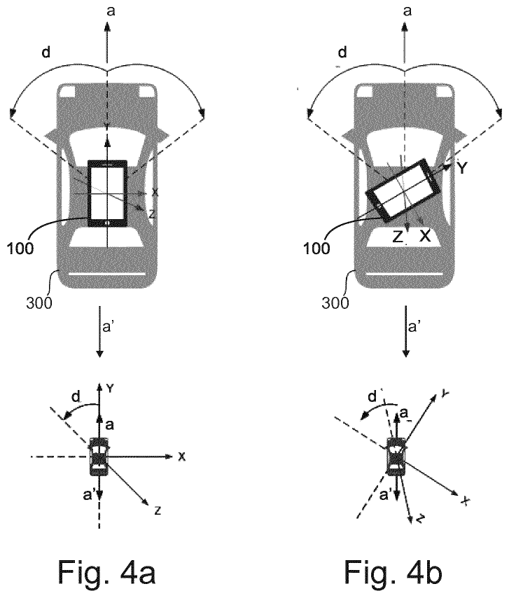

The problem is further illustrated in FIGS. 4a and 4b also showing the effect of different sensor orientations on the interpretability of rotations (e.g., steering manoeuvres). In FIG. 4a the device 100 is aligned with the vehicle 300 so that the coordinate systems of the device 100 and the vehicle 300 are aligned. In FIG. 4b the device 100 is not aligned with the vehicle 300, wherein the coordinate systems of the device 100 and the vehicle 300 are not aligned. In FIGS. 4a and 4b the vehicle acceleration vector is illustrated with an arrow a or a′. The arrow a indicates acceleration in the forward direction i.e. the velocity of the vehicle 300 increases, whereas the arrow a′ indicates acceleration in the backward direction i.e. the velocity of the vehicle 300 decreases. When the coordinate systems of the device 100 and the vehicle 300 are aligned, the vehicle acceleration vector a can be expressed as aₓ=0, a_{y}=|a|, a_{z}=0 or a′ₓ=0, a′_{y}=−|a′|, a′_{z}=0. If the vehicle 300 turns left (rotation by degree d around axis Z), gₓ=0, g_{y}=0, g_{z}=d. These values can be obtained from the device 100. In the situation when the coordinate systems of the device 100 and the vehicle 300 are not aligned, the acceleration and the rotation may not be obtained directly from the information provided by the sensor device 100 but a conversion may be needed.

In other words, the two coordinate systems and their unaligned state may cause that if the relative orientation of the vehicle and the sensor (i.e., in mathematical terms, the rotation matrix transforming vectors from the sensor's coordinate system to the vehicle's coordinate system) is not known, the sensor data coming from a vehicle is not intuitively and unambiguously interpretable. Acceleration and gyroscope motions measured by the sensor could have been caused by many different vehicular movements, depending on the relative orientation of the sensor and the vehicle. Furthermore, measurements originating from different vehicles may not be comparable with each other. In fact, different sensor data might have been generated by the same or similar movements, or different movements may generate same or similar sensor data. The ambiguity in sensor data interpretation may make the training of machine learning algorithms (e.g., tasked to recognize the pattern of various manoeuvers) very hard, and their achievable accuracy may become severely limited because of noise in the data, such as a mixture of different real-world motion patterns under the same motion label.

In the following, an example is described in which the misalignment of the sensor coordinate system and the vehicle coordinate system is detected so that the original sensor data expressed in the sensor's arbitrary coordinate system may be transformed into the vehicle's known coordinate system. This information may then be used to determine the position (orientation) of the sensor device with respect to the vehicle. In the method energy intensive GPS or error prone magnetic sensors are not needed but only commodity accelerometer and gyroscope sensors may be used with advanced analytics. The vehicle's forward direction is derived from acceleration vector directions collected during straight line accelerations. Suitable periods to collect such directions are detected only by analysing the pattern of accelerations and rotations, without using GPS speed or odometer speed. The exact direction of the vehicle's vertical axis (up/down) is isolated from the axis of the significant gyroscope rotation vectors and the upwards direction is selected by directing the axis towards the opposite of gravity. The gravity (i.e., roughly downward) component is extracted from the acceleration data but ifs direction is not used as it is to conclusively identify the exact downward direction, so that the method may become insensitive to non-horizontal surfaces. The rightward direction may be derived from the forward and upward directions to form a right-handed coordinate system. From the representation of the three directions in the sensor's coordinate system, a rotation matrix is calculated that transforms vectors from the sensor's coordinate system to the vehicle's coordinate system. The rotation matrix may be re-calculated periodically or after significant motion is detected to compensate for the device's potential movement inside the vehicle.

The rotation matrix is applied to the motion data vectors produced by the onboard sensor to create a vehicle motion representation that stays fixed to the vehicle's frame (instead of relative to the arbitrarily oriented sensor). The transformed data is analysed to recognize various vehicle manoeuvres or detect the impact of the environment (such as the quality of road surface). The method is applicable to multiple vehicles by running separate method instances simultaneously, each processing the data of one vehicle as the sensors in different vehicles may be oriented differently and independently.

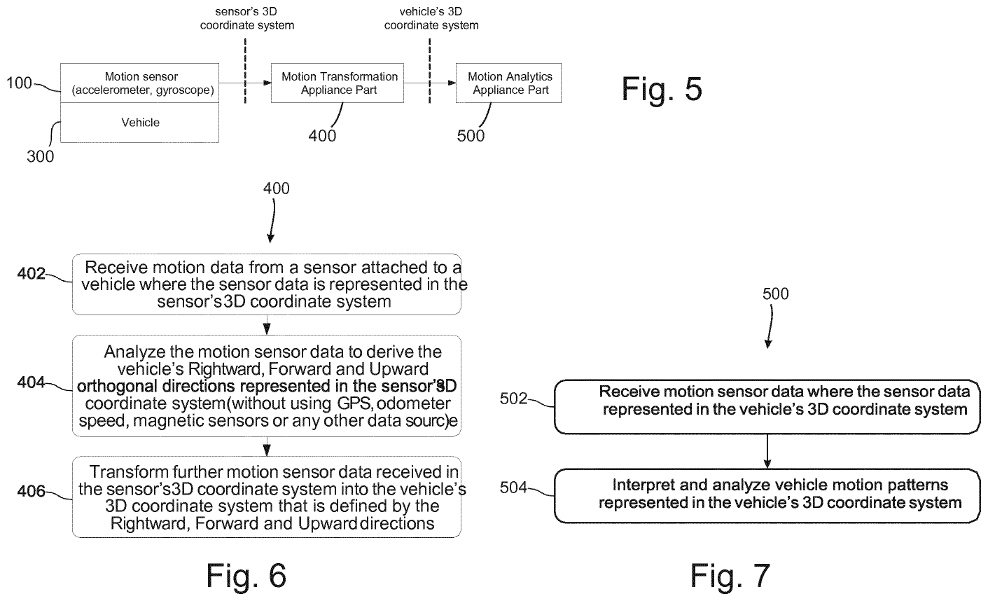

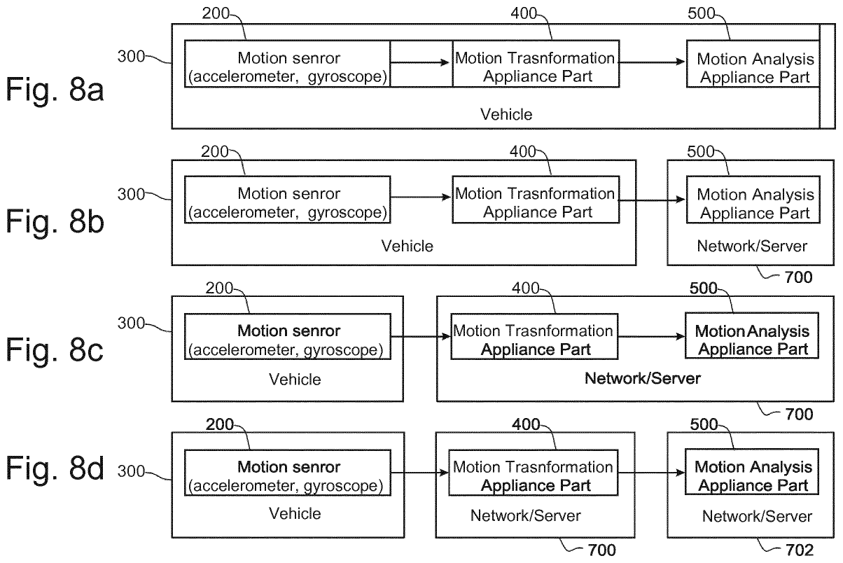

The high-level architecture of the invention is shown in FIG. 5, in accordance with an embodiment. Two parts are defined. A first part is a motion transformation appliance part 400 and a second part is a motion analytics appliance part 500. The operation of the motion transformation appliance part 400 is outlined in FIG. 6 and the operation of the motion analytics appliance part is outlined in FIG. 7.

The motion transformation appliance part 400 receives 402 motion sensor data from a vehicle expressed in the sensor's coordinate system. Then, the motion transformation appliance part 400 analyzes 404 the motion sensor data to derive vehicle's rightward R, forward F and upward U orthogonal directions represented in the sensor's 200 (or the device's 100) coordinate system. The motion transformation appliance part 400 also transforms 406 the motion sensor data into the vehicle's coordinate system.

The motion analytics appliance part 500 receives 502 motion sensor data expressed in the vehicle's coordinate system and interprets and analyzes 504 the vehicle motion patterns represented in the vehicle's 3D coordinate system to recognize various manoeuvers or road surface conditions, for example.

As the transformed motion representation may harmonize data produced by different vehicle sources, the same manoeuvre performed by different vehicles may generate same or similar motion data. This makes knowledge obtained from the observation of one vehicle applicable to understand and analyse the motion of another vehicle and may enable efficient per-vehicle and cross-vehicle manoeuvre analysis.

In the following, an example implementation of an apparatus 600 is described in more detail. It is assumed that the vehicle 300 has a motion sensor 200 located on-board. The motion sensor 200 may be embedded in or part of the vehicle's electrical and information system; it may be in a sensor placed in the vehicle during post-market installation; it may be a sensor that is inside a device 100 brought on-board the vehicle 300 but which is not part of the vehicle, such as a smartphone having motion sensors 200, or a purpose-build device with motion sensors 200 and communication interfaces to access the motion sensor data.

The above mentioned operational blocks, i.e., the motion transformation appliance part 400 and the motion analytics appliance part 500, may be co-located or integrated with the sensor 200, vehicle 300 or the apparatus 100 hosting the motion sensors 200 inside the vehicle 300, or they may be running on the same or different network elements or servers accessible and interconnected through one or more networks that are employed to obtain the sensor data from the source and to transfer sensor data between the two parts 400, 500. Various logical deployment options are depicted in FIGS. 8a-8d. In the example of FIG. 8a the motion sensors 200, the motion transformation appliance part 400 and the motion analytics appliance part 500 are each within the vehicle 300. In the example of FIG. 8b the motion sensors 200 and the motion transformation appliance part 400 are within the vehicle 300 but the motion analytics appliance part 500 is in a network 700, for example in a server of the network 700. In the example of FIG. 8c the motion sensors 200 are within the vehicle 300, but the motion transformation appliance part 400 and the motion analytics appliance part 500 are in the network 700, for example in the server of the network 700. In the example of FIG. 8d the motion sensors 200 are within the vehicle 300, but the motion transformation appliance part 400 is in a first network 700, for example in a server of the first network 700, and the motion analytics appliance part 500 is in a second network 702, for example in a server of the second network 702. In the examples of FIGS. 8a and 8b an interface between the motion sensor(s) 200 and the motion transformation appliance part 400 may be an application programming interface (API), such as the Android Sensor API, if the platform hosting the motion sensors 200 is running Android operating system. However, it should be noted that any other hardware and software stack or other APIs may also be equally usable. In the examples of FIGS. 8c and 8d the interface between the motion sensor(s) 200 and the motion transformation appliance part 400 comprises a network connection such as an application layer or data representation protocol (e.g., JSON, ProtoBuf, REST, etc.), a transport and network layer protocol (e.g., TCP/IP, or TLS/TCP/IP for encrypted connections) and a wired or wireless physical layer protocol (e.g., CAN bus, Ethernet, Bluetooth, Wi-Fi, LTE, LTE-A, NB-IoT, LTE-M, 5G, etc.).

The interface between the motion transformation appliance part 400 and the motion analytics appliance part 500 may be based on similar implementation principles as the interface between the motion sensor 200 and the motion transformation appliance part 400. The interface may also be an internal (e.g., in-memory, function call, etc.) interface of the two parts which may be implemented in a single software solution.

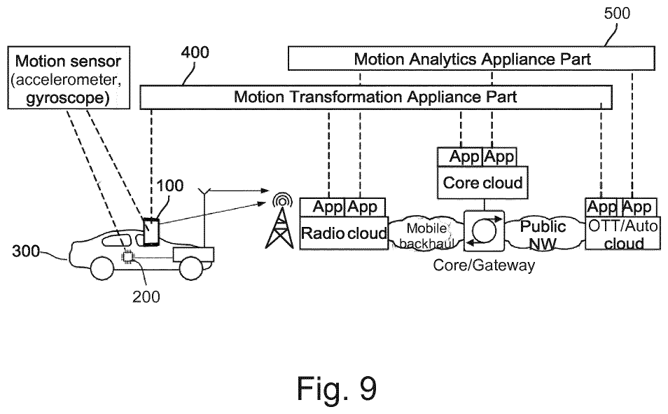

One deployment option in mobile networks is shown in FIG. 9. The motion sensor 200 may be located in a vehicle 300 as discussed previously; the motion transformation appliance part 400 and the motion analytics appliance part 500 may be running as software implementations on one or more edge clouds (such as MEC), core clouds, or clouds accessible over the Internet. The motion transformation appliance part 400 and the motion analytics appliance part 500 may be running on the same or different clouds.

In the following, the more detailed description of the motion transformation appliance part 400 and motion analytics appliance part 500 are given.

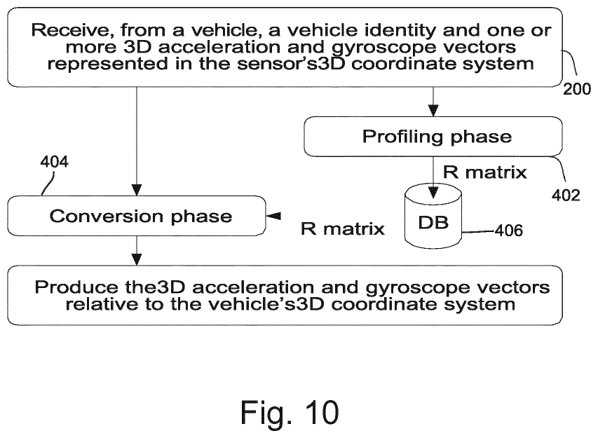

The high-level implementation of the motion transformation appliance part 400 is shown in FIG. 10. The sensors 200 used by the implementation are the accelerometer (non-linear, i.e., including the force of gravity) and the non-magnetic gyroscope sensors. The implementation has two phases: a profiling phase 402 and a conversion phase 404.

The profiling phase 402 is responsible for discovering the sensor's orientation within the vehicle 300 by recognizing the vehicle's directions describing its degrees of freedom (forward, upward, rightward) and calculating a rotation matrix for the vehicle. The rotation (R) matrix may be stored in a database (DB) 406.

The conversion phase 404 may be activated when the profiling phase 402 has produced the rotation matrix for the vehicle. The conversion phase 404 also transforms the motion sensor data from the sensor's coordinate system to the vehicle's coordinate system using the R matrix of the vehicle 300.

It should be noted that an implementation may handle multiple vehicles, in which case the sensor data and the R matrix are handled separately for each vehicle.

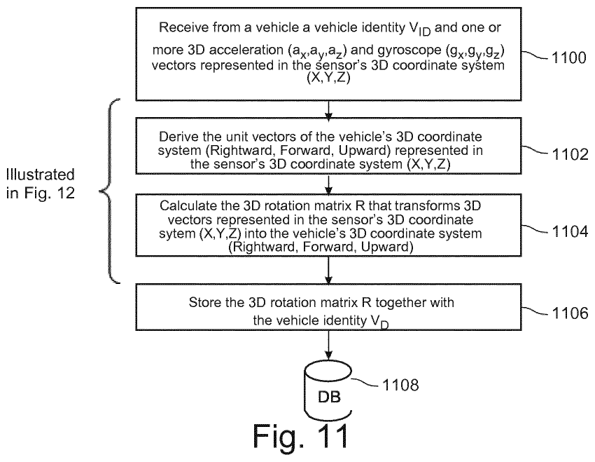

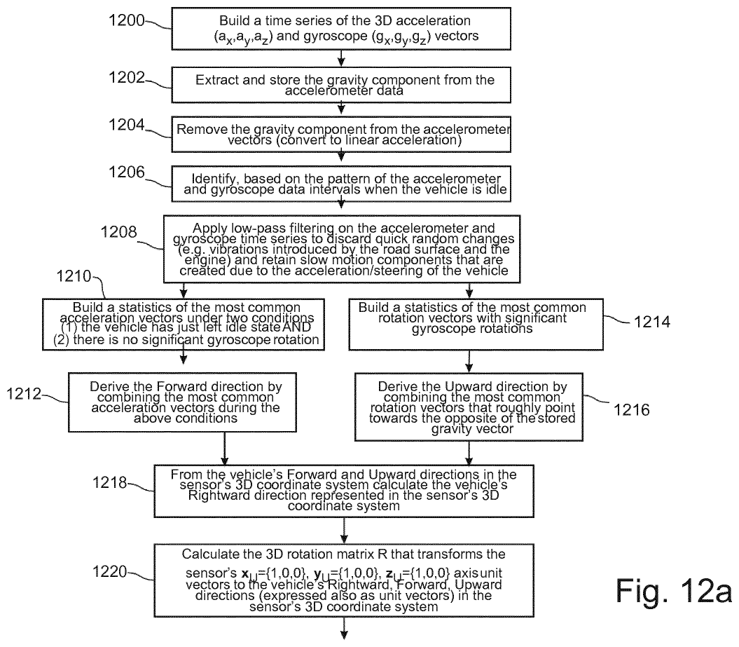

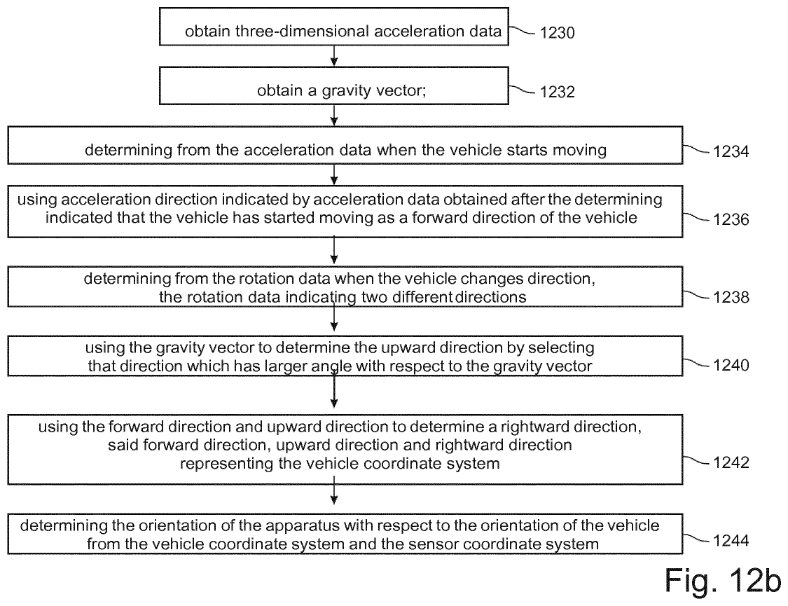

FIGS. 11, 12a and 12b depict more details of the implementation of the profiling phase 402. In addition to the motion sensor data, a vehicular identity may also be taken as an input to enable the separate processing of data coming from multiple vehicles as well as to enable calculating and storing a rotation matrix separately for each vehicle (block 1100 in FIG. 11). Unit vectors of the vehicle's 3D coordinate system is derived 1102 and a rotation matrix is calculated 1104. The results may be stored 1106 to a database 1108.

The profiling is performed on a time series representation of the original motion sensor data expressed in the sensor's X, Y, Z coordinate system (block 1200 in FIG. 12). The time series is built by sampling the data with a given frequency, with may be the natural frequency at which the sensor produces data, or it may be re-sampled (e.g., using a moving average process). First the gravity component is identified from the accelerometer (e.g., using low pass filtering or moving average process) and stored for later use to differentiate between up and down directions (block 1202). In order to avoid the problem of non-horizontal roads, the gravity direction may not be used to directly define the upward direction. Afterwards, the accelerometer data is cleaned from the gravity component (block 1204) to result in a linear accelerometer data. Alternatively, a linear accelerometer sensor source may be used directly, if available. Using the linear accelerometer and gyroscope data, the profiling performs basic idle detection to identify when the vehicle is not in motion (block 1206). The idle detection uses pattern analysis to identify when there are no vibrations and micro-motions that indicate the vehicle is in motion. In accordance with an embodiment, the amount of vibrations and/or micro-motions may be compared with a threshold and if it is determined that the amount of vibrations and/or micro-motions is less than the threshold, it may still be determined that the vehicle is not in motion. For example, if an engine of the vehicle is running some vibrations may be detected although the vehicle is not in motion. Outside of the idle periods, the profiling may apply low-pass filtering or de-noising (e.g., moving average) to smoothen the accelerometer and gyroscope time series and limit the impact of road surface or combustion engine originated vibrations modulating the sensor data and isolate the acceleration and turn manoeuvres of the vehicle (block 1208). The non-idle periods are analysed further in two processing paths: one is to derive the forward direction from accelerations, another is to derive the upward direction from rotations. The processing paths may be executed in parallel.

In one processing path, the cleaned sensor data time series is analysed for forward acceleration collecting a multitude of accelerometer vector directions from periods of time when the vehicle has just left the idle state (i.e., it is accelerating) and there is no rotation (i.e., it is moving along a straight trajectory) (block 1210). The accelerometer vector directions indicate the direction of movement in the sensor coordinates. In other words, the accelerometer indicates that the sensor device moves to the direction of the vector. The benefit of collecting acceleration directions under these conditions is that the majority of the collected samples correspond roughly to the forward direction of the vehicle without getting affected by accelerations during turns that might scatter the collected directions considerably (block 1212). Hence, the acceleration vector indicates the forward direction of the vehicle. Even though negative (backwards) acceleration samples may also be recorded (e.g., when the driver or the automatic transmission shifts gear, the transmission between the engine and the wheels is intercepted using the clutch, or simply the gas pedal is not constantly pressed), the majority of the acceleration vectors represents the forward direction due to the fact that the vehicle is getting from still to motion, therefore its cumulated acceleration is positive towards the forward direction. A benefit of the method in which the straight acceleration periods are detected is that it does not rely on any GPS information whatsoever. The profiling derives the forward direction from the most frequent acceleration directions, e.g., by discarding the most isolated directions (those vectors whose next closest direction is separated by a considerable angle) and calculating the average of the remaining ones.

In another processing path, the cleaned sensor data time series is analysed to collect a multitude of rotations from the gyroscope (block 1214). Each rotation defines a vector around which the rotation with a given angular speed is measured. As the rotation vectors with significant angular speeds represent the left and right turns of the vehicle around its vertical axis, the rotation vectors define two directions: those pointing towards the top and towards the bottom of the vehicle. The two directions exist as left and right turns generate rotation vectors pointing in the opposite directions. Since the gyroscope data does not contain information about which direction is up or down along the vertical axis, an additional reference is used to differentiate between them. In accordance with an embodiment, the differentiation is done by comparing the two candidate directions to the direction of gravity: the direction that is further from (i.e., has a wider angle from) the direction of gravity is the upward direction (block 1216). This selection method does not require that the vehicle is at a horizontal surface: as long as the vehicle is not upside down, the gravity force points through the bottom of the vehicle and not through its top, which is enough to find which direction of the rotation vector points exactly towards the top of the vehicle. This is another benefit of how gravity is used in this solution without requiring a horizontal surface calibration step to identify the vertical direction—no such calibration is needed here.

The identified forward and upward directions are represented by a unit vector, in sensor coordinate system, pointing to the given direction (block 1218). These are denoted by a forward unit vector f_{U} and an upward unit vector u_{U}. The rightward unit vector r_{U} is calculated as the cross product of the forward and upward unit vectors, i.e., r_{U}=f_{U}×u_{U} where x is the vector cross product operator. In accordance with an embodiment, the forward direction unit vector may be re-calculated as f_{U}=u_{U}×r_{U} to make the three directions perpendicular to compensate for any vertical inclination that the forward direction may have as forward acceleration may slightly elevate the front of a vehicle as the torque force propagates through its frame's suspension spring system.

The direction unit vectors r, f and u (rightward, forward and upward) define the vehicle's coordinate system as a right-handed coordinate system relative to the sensor's X, Y, Z coordinate system. In the sensor's coordinate system, the sensor's coordinate system itself is defined by the direction unit vectors x_{U}=(1, 0, 0), y_{U}=(0, 1, 0) and z_{U}=(0, 0, 1).

Next, the rotation matrix R is calculated that transforms the {x_{U}, y_{U}, z_{U}} coordinate system into the {r_{U}, f_{U}, u_{U}} coordinate system and hence any vector expressed on the sensor's coordinate system into the vehicle's system (block 1220). The R matrix is defined as:

$$R = [ \begin{matrix}cos ( {x}_{U} , {r}_{U} ) & cos ( {x}_{U} , {f}_{U} ) & cos ( {x}_{U} , {u}_{U} ) \\ cos ( {y}_{U} , {r}_{U} ) & cos ( {y}_{U} , {f}_{U} ) & cos ( {y}_{U} , {u}_{U} ) \\ cos ( {z}_{U} , {r}_{U} ) & cos ( {z}_{U} , {f}_{U} ) & cos ( {z}_{U} , {u}_{U} )\end{matrix} ]$$

where cos(a,b) denotes the cosine of the angle between the vectors a and b. As indicated above, the detailed steps of the above procedure are illustrated in FIG. 12.

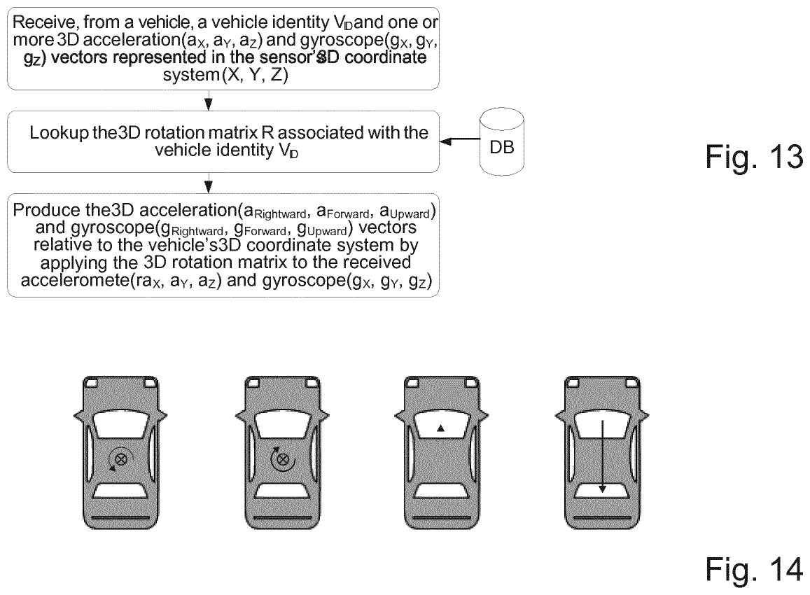

Further details on implementing the conversion phase are disclosed in FIG. 13. The conversion phase utilizes the same data source as the profiling phase, i.e., it obtains motion vectors from the sensor expressed in the sensor's coordinate system. In addition to the sensor data, a vehicle identity may also be taken into consideration to enable separate processing of sensor data coming from multiple vehicles, if such option is used. The conversion phase obtains the rotation matrix calculated by the profiling phase. The matrix is applied to transform vectors from the sensor's coordinate system to the vehicles coordinate system as follows:

$$[ \begin{matrix}{v}_{1} \\ {v}_{2} \\ {v}_{3}\end{matrix} ] = R \cdot [ \begin{matrix}{s}_{1} \\ {s}_{2} \\ {s}_{3}\end{matrix} ]$$

where s=(s₁, s₂, s₃) is a motion (acceleration or gyroscope rotation) vector in the sensor's coordinate system and v=(v₁, v₂, v₃) is the motion vector transformed to the vehicle's coordinate system. For example, an acceleration vector (a_{X}, a_{Y}, a_{Z}) in the sensor's coordinate system is transformed into the vehicle's coordinate system as (a_{Rightward}, a_{Forward}, a_{Upward}) as follows:

$$[ \begin{matrix}{a}_{Rightward} \\ {a}_{Forward} \\ {a}_{Upward}\end{matrix} ] R \cdot [ \begin{matrix}{a}_{X} \\ {a}_{Y} \\ {a}_{Z}\end{matrix} ]$$

In FIG. 12b an example embodiment of a method is shown. Sensor data is obtained 1230 from at least one motion sensor associated with a vehicle, said sensor data comprising three-dimensional acceleration data from an accelerometer and three-dimensional rotation data from a gyroscope with respect to a sensor coordinate system. A gravity vector is obtained 1232 and it is determined 1234 from the acceleration data when the vehicle starts moving. Acceleration direction indicated by acceleration data obtained after the determining indicated that the vehicle has started moving is used 1236 as a forward direction of the vehicle. It is determined 1238 from the rotation data when the vehicle changes direction, the rotation data indicating two different directions. The gravity vector is used 1240 to distinguish from the two different directions which is an upward direction of the vehicle by selecting from the two different directions that direction which has larger angle with respect to the gravity vector as the upward direction. The forward direction and upward direction are used 1242 to determine a rightward direction, said forward direction, upward direction and rightward direction representing the vehicle coordinate system. The orientation of the apparatus with respect to the orientation of the vehicle is determined 1244 from the vehicle coordinate system and the sensor coordinate system.

In the following, some details of the operation of the motion analytics appliance part 500 are disclosed, in accordance with an embodiment.

The motion analytics appliance part 500 takes motion sensor data expressed in the vehicle's coordinate system and analyses the data to detect various common manoeuvres. The analytics may be implemented using machine learning based pattern matching algorithms such as RNN or specifically LSTM, trained on labelled data to recognize one or more of the following motion primitives: left turn, right turn, accelerate, brake. The essence of such primitives and their most distinctive accelerometer/gyroscope axis in the vehicle's coordinate system is illustrated in FIG. 14. Left or right turn primitives are best recognized by looking for left or right rotations in the gyroscope data along the vehicle axis upward and acceleration or brake primitives may be recognized by looking for acceleration along the positive or negative vehicle axis forward. A left turn may affect that the gyroscope data has a positive value and, respectively, a right turn may affect that the gyroscope data has a negative value. A positive acceleration value in the forward axis direction indicates that the velocity of the vehicle increases and a negative acceleration value in the forward axis direction indicates that the velocity of the vehicle decreases.

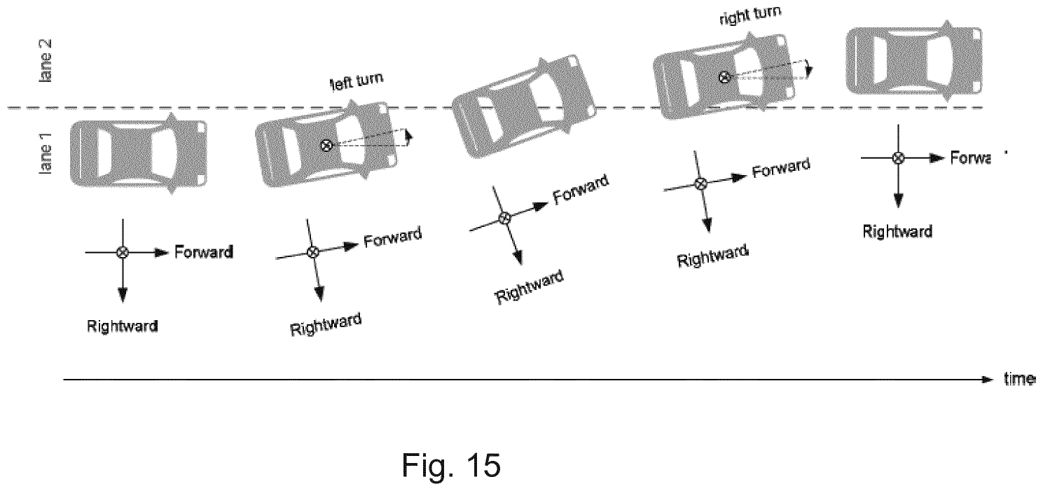

In addition to motion primitives, more complex physical manoeuvres such as lane change may be recognized by the analytics (example left lane change and the corresponding rotations are shown in FIG. 15, showing how the vehicle's coordinate system stays fixed relative to the vehicle's orientation during the manoeuvre). Lane changes may be recognized by analysing the gyroscope data and looking for subsequent left-right or right-left rotations along the vehicle axis upward.

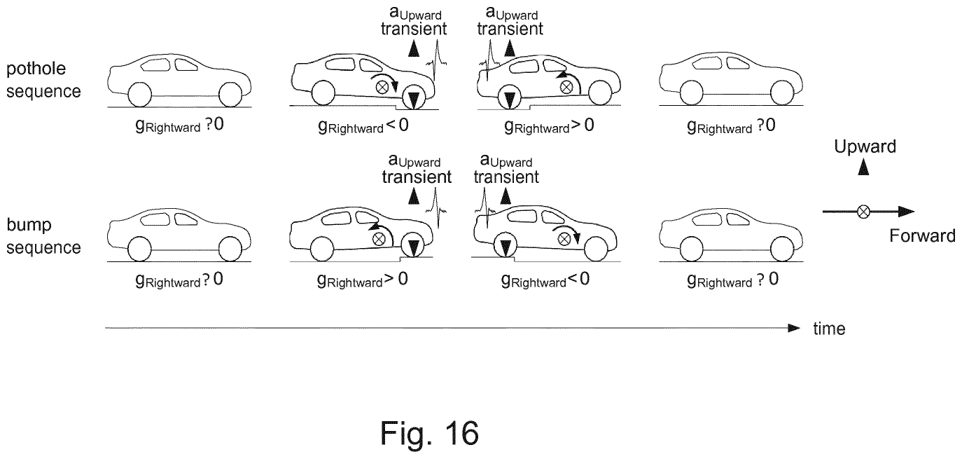

In addition to recognizing physical manoeuvres, the analytics may also be used to detect the road surface quality as it also has an impact on the motion sensor data. In FIG. 16, the recognition of two types of road surface problems, i.e., pothole and bump are shown. One prominent indicator is the rotation around the vehicle axis rightward (which points towards the viewer in FIG. 16), as well as the transient peak and abrupt oscillation in the acceleration along the vehicle upwards direction. Potholes and bumps may be differentiated based on the direction the oscillation and rotation sequence starts. For potholes, the vehicle first drops its front, generating a mathematically negative rightward rotation, then in the end lifts its front, generating a mathematically positive rightward rotation; with bump, the order is the other way around.

In addition to detecting motion primitives, manoeuvres and the impact of road surface quality, the analytics may also be used to quantify the detected events via various attributes. Common attributes include the duration of the events, or the magnitude of the event (e.g., what was the rotational speed or acceleration experienced by the vehicle, or how rough is the road pothole/bump). The frequency or specific sequences of the events can also be calculated, e.g., alternating acceleration and brake patterns with significant magnitude, or frequent rapid lane changes, that could be indicative of dangerous driving attitude.

The detected manoeuvres and road surface quality impacts may also be analysed on a map to put them into context, enabling contextual driver behaviour analysis and cause analysis for the detected behaviour.

It may happen that the vehicle starts to move backwards from the still position. Therefore, in accordance with an embodiment, the apparatus 100 may also receive information from a transmission system of the vehicle 300 to indicate whether the direction of movement is forwards or backwards (i.e. reversing the vehicle). The backwards direction may be determined by examining the information from the transmission system if a reverse gear is selected or not. Therefore, the method may also use the backwards movement instead of or in addition to the forward movement to determine the backward direction of the vehicle.

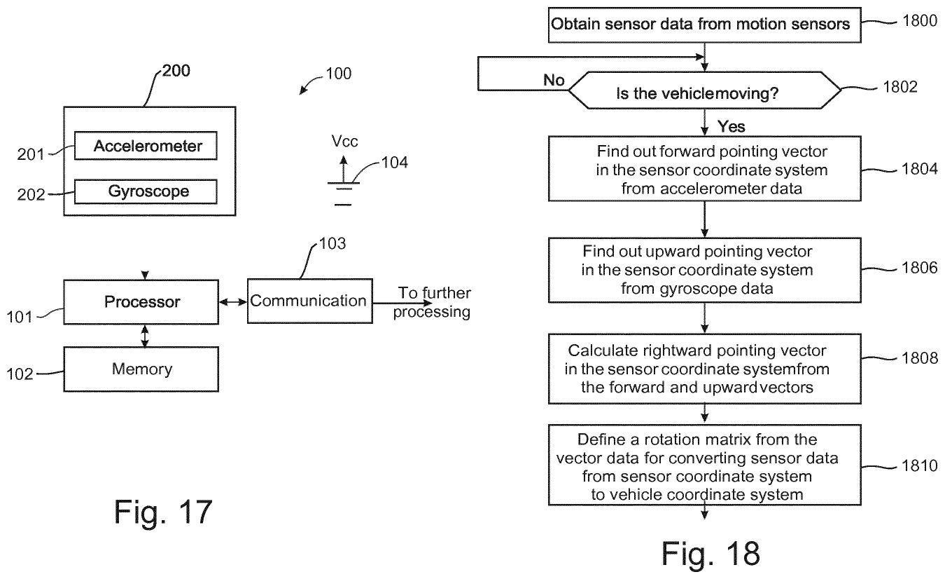

FIG. 17 depicts an example of an apparatus 100, which may be, for example, a separate device or a part of another device, such as a smart phone or another kind of a mobile phone, a tablet computer, a laptop computer, a navigator, etc. The apparatus 100 comprises motion sensors 200 such as an accelerometer 202 (non-linear or linear accelerometer) and a gyroscope 204. The accelerometer 202 outputs three-dimensional acceleration data i.e. one acceleration data component for each of the coordinate directions of the sensor coordinate system. Correspondingly, the gyroscope 204 outputs three-dimensional rotation data i.e. one rotation data component for each of the coordinate directions of the sensor coordinate system. It is assumed here that both the accelerometer 202 and the gyroscope 204 are installed so that they have the same sensor coordinate system.

Data from the motion sensors 200 may be analogue, digital, pulse width modulated or in some other appropriate form, but in this specification it is assumed that the data is in digital form i.e. output as digital samples. Therefore, the motion sensors 200 take care of possible conversions from the format provided by the sensor to the digital format.

Outputs of the motion sensors 200 are coupled to the processor 101 which receives the data and preform the operations described above in this specification. The apparatus 100 also comprises at least one memory 102 for storing sensor data, parameters, rotation matrix, computer code to be executed by the processor 101 for different operations, etc.

The apparatus 100 of FIG. 17 also comprises a communication element 103 for providing the vehicle motion information such as a series of motion vectors transformed to the vehicle's coordinate system to be used by other device(s). The communication element 103 may communicate in a wireless and/or wired manner with other devices. For wireless communication the communication element 103 is a Bluetooth™ communication element, a WiFi communication element, an NFC (near field communication) element or another kind of short range communication element.

The apparatus 100 may communicate with another device, such as a smart phone or another mobile phone, which may produce information to e.g. a driver of the vehicle on manoeuvres of the vehicle or transmit the information to a communication network 700.

In accordance with an embodiment, the communication element 103 of the apparatus 100 comprises means for communicating with a wireless communication network 700.

In accordance with the embodiments illustrated in FIG. 8b the apparatus 100 only performs the motion transformation appliance part 400, wherein information produced by the motion transformation appliance part 400 is transmitted to the network 700. The apparatus 100 may also communicate the sensor data to the network so that the network 700 may use the sensor data together with the data provided by the motion transformation appliance part 400 to perform the motion analytics appliance part 500 and possible further processing of data from the motion analytics appliance part 500.

In accordance with the embodiments illustrated in FIGS. 8c and 8d the apparatus 100 only performs the initial processing of sensor data and communicates the sensor data to the network 700. FIG. 18 depicts as a flow diagram an example embodiment of the operation of a method. In step 1800 sensor data is obtained from the motion sensors 201, 202. In step 1802 the sensor data is examined to determine whether the vehicle 300 is standing still or begins to move forward. When it is determined that the vehicle 300 starts moving forward, in step 1804 the accelerometer data is examined to find out a vector in the sensor coordinate system which points to the forward direction of the motion. In step 1806, which may be parallel or subsequent to step 1804, the rotation data is analyzed to find out a vector in the sensor coordinate system which points to the upward direction with respect to the motion. In step 1808 the forward and upward directions are used to calculate a vector in the sensor coordinate system pointing in a rightward direction of the motion. In step 1810 these vectors are used to define a rotation matrix for converting sensor data from the sensor coordinate system to the vehicle coordinate system.

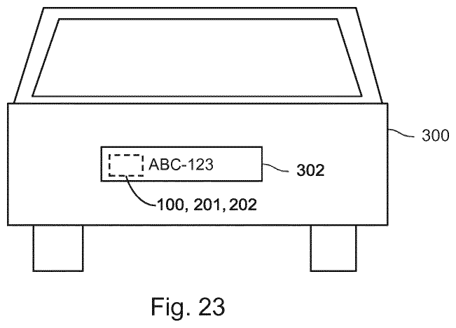

In accordance with an embodiment, the motion sensors 201, 202 may also be attached with a register plate 302 of a vehicle 300. For example, the motion sensor 201, 201 may be integrated in a hollow space in the register plate 302, on a surface of a backside of the register plate 302, etc. In addition to the motion sensors 201, 202, also the communication element 103 of the apparatus, or all the whole apparatus 100 may be attached with the register plate 302 of the vehicle 300. There may also be a power source such as a battery for supplying power to the elements of the apparatus which are attached with the register plate. These elements may have such a low power consumption that the battery may have enough capacity to supply power for several years. In accordance with an embodiment, the electric energy for the elements may be provided by some device which is able to generate electricity from movements such as vibrations. An example of such a device is a piezo-electric device. FIG. 23 is a simplified illustration of the apparatus 100 and motion sensors 210, 202 attached with the register plate 302 of the vehicle 300.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

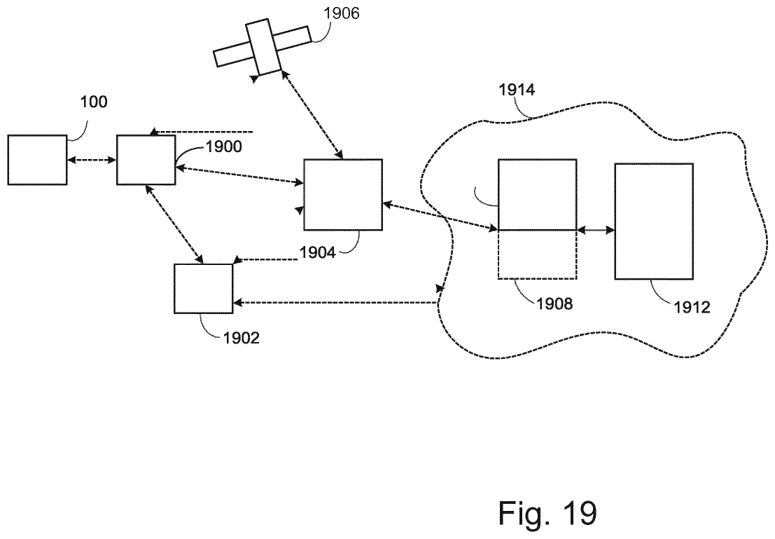

FIG. 19 depicts examples of simplified system architectures only showing some elements and functional entities, all being logical units, whose implementation may differ from what is shown. The connections shown in FIG. 19 are logical connections; the actual physical connections may be different. It is apparent to a person skilled in the art that the system typically comprises also other functions and structures than those shown in FIG. 19.

The embodiments are not, however, restricted to the system given as an example but a person skilled in the art may apply the solution to other communication systems provided with necessary properties.

The example of FIG. 19 shows a part of an exemplifying radio access network.

FIG. 19 shows user devices 1900 and 1902 configured to be in a wireless connection on one or more communication channels in a cell with an access node (such as (e/g)NodeB) 1904 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 1910 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 19) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 1912, or utilise services provided by them. The communication network may also be able to support the usage of cloud services, for example at least part of core network operations may be carried out as a cloud service (this is depicted in FIG. 19 by “cloud” 1914). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 1904) and non-real time functions being carried out in a centralized manner (in a centralized unit, CU 1908).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 1906 in the mega-constellation may cover several satellite-enabled network entities that create on-ground cells. The on-ground cells may be created through an on-ground relay node 1904 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 19 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 19). A HNB Gateway (HNB-GW), which is typically installed within an operator's network may aggregate traffic from a large number of HNBs back to a core network.

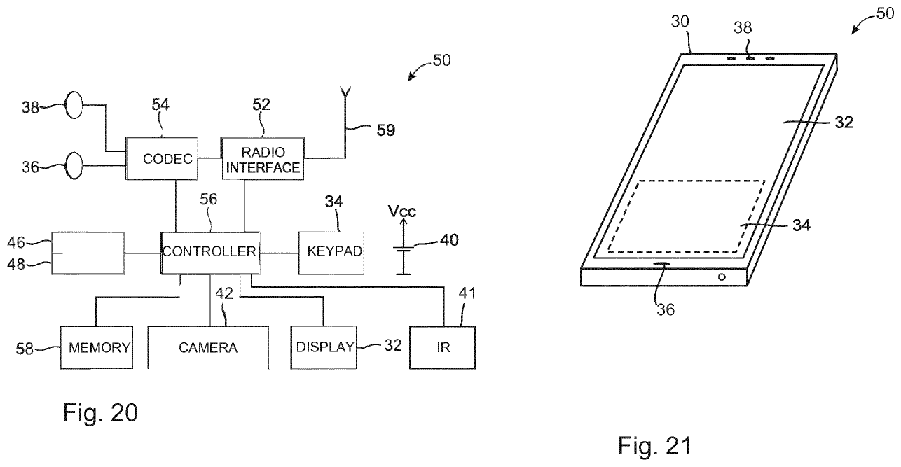

The following describes in further detail suitable apparatus and possible mechanisms for implementing some embodiments. In this regard reference is first made to FIG. 20 which shows a schematic block diagram of an exemplary apparatus or electronic device 50 depicted in FIG. 21, which may incorporate a transmitter according to an embodiment of the invention.

The electronic device 50 may for example be a mobile terminal or user equipment of a wireless communication system. However, it would be appreciated that embodiments of the invention may be implemented within any electronic device or apparatus which may require transmission of radio frequency signals.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The term battery discussed in connection with the embodiments may also be one of these mobile energy devices. Further, the apparatus 50 may comprise a combination of different kinds of energy devices, for example a rechargeable battery and a solar cell. The apparatus may further comprise an infrared port 41 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a universal integrated circuit card (UICC) reader and UICC for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 59 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera 42 capable of recording or detecting imaging.

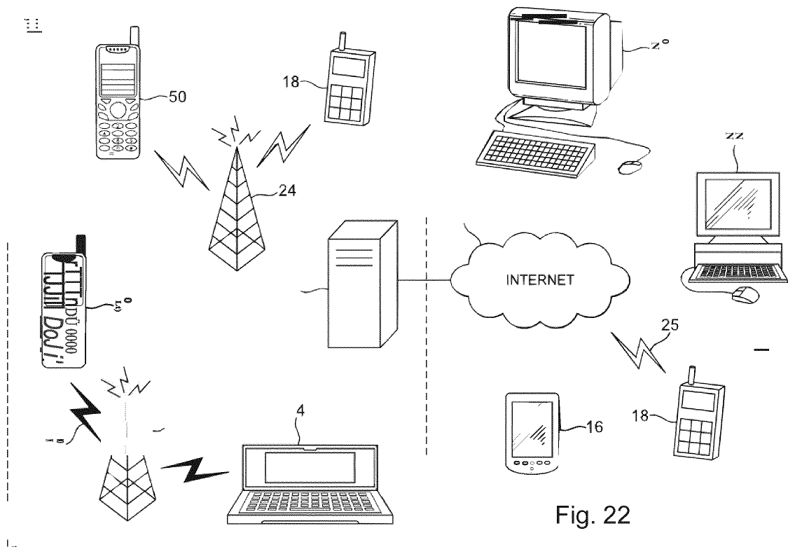

With respect to FIG. 22, an example of a system within which embodiments of the present invention can be utilized is shown. The system 10 comprises multiple communication devices which can communicate through one or more networks. The system 10 may comprise any combination of wired and/or wireless networks including, but not limited to a wireless cellular telephone network (such as a GSM (2G, 3G, 4G, LTE, 5G), UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system shown in FIG. 22 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22, a tablet computer. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, Long Term Evolution wireless communication technique (LTE) and any similar wireless communication technology. Yet some other possible transmission technologies to be mentioned here are high-speed downlink packet access (HSDPA), high-speed uplink packet access (HSUPA), LTE Advanced (LTE-A) carrier aggregation dual- carrier, and all multi-carrier technologies. A communications device involved in implementing various embodiments of the present invention may communicate using various media including, but not limited to, radio, infrared, laser, cable connections, and any suitable connection. In the following some example implementations of apparatuses utilizing the present invention will be described in more detail.

Although the above examples describe embodiments of the invention operating within a wireless communication device, it would be appreciated that the invention as described above may be implemented as a part of any apparatus comprising a circuitry in which radio frequency signals are transmitted and/or received. Thus, for example, embodiments of the invention may be implemented in a mobile phone, in a base station, in a computer such as a desktop computer or a tablet computer comprising radio frequency communication means (e.g. wireless local area network, cellular radio, etc.).

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules, field-programmable gate arrays (FPGA), application specific integrated circuits (ASIC), microcontrollers, microprocessors, a combination of such modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-29. (canceled)

30. An apparatus, comprising:
at least one processor; and
at least one memory including computer program code, the at least one memory and computer program code configured to, with the at least one processor, cause the apparatus at least to:
obtain sensor data from at least one motion sensor located on-board a vehicle, said at least one motion sensor comprising an accelerometer and a gyroscope, said motion sensor having a sensor coordinate system and said vehicle having a vehicle coordinate system, said sensor data comprising three-dimensional acceleration data from the accelerometer and three-dimensional rotation data from the gyroscope with respect to the sensor coordinate system;
sample a series of acceleration data from the accelerometer and rotation data from the gyroscope;
obtain a gravity vector on the basis of the series of acceleration data;
remove the gravity vector from the acceleration data to obtain linear acceleration data;
determine by analyzing the sensor data that the vehicle is in an idle state when the linear acceleration data indicates that the amount of vibrations of the vehicle is less than a threshold;
determine from the linear acceleration data and rotation data when the vehicle has left the idle state and starts moving in straight line;
use acceleration direction indicated by a majority of acceleration data in the series of acceleration data collected when the vehicle starts moving in a straight line as a forward direction of the vehicle, when the determining indicated that the vehicle has started moving in straight line;
profile the series of rotation data into two different directions;
compare the gravity vector with the two different directions;
select from the two different directions that direction which has the largest angle with respect to the gravity vector as the upward direction;
use the forward direction and upward direction to determine a rightward direction, said forward direction, upward direction and rightward direction representing the vehicle coordinate system;
detect misalignment of the sensor coordinate system and the vehicle coordinate system on the basis of the forward direction, upward direction and the rightward direction represented in the sensor coordinate system; and
determine the orientation of the motion sensor with respect to the orientation of the vehicle on the basis of the misalignment of the vehicle coordinate system and the sensor coordinate system.

31. The apparatus according to claim 30, wherein the at least one memory and the computer program code are further configured to, with the at least one processor, cause the apparatus to:
build statistics from the series of rotation data;
store the gravity vector; and
derive the upward direction by combining the most common rotation vectors that roughly point towards the opposite of the stored gravity vector.

32. The apparatus according to claim 30, wherein the at least one memory and the computer program code are further configured to, with the at least one processor, cause the apparatus:
determine by analyzing motion sensor data that the vehicle is moving when sensor data indicates vibrations of the vehicle; and
analyze the motion sensor data to detect various movement maneuvers.

33. The apparatus according to claim 30, wherein the at least one memory and the computer program code are further configured to, with the at least one processor, cause the apparatus to:
define a rotation matrix that transforms the sensor coordinate system to the vehicle coordinate system on the basis of the misalignment of the vehicle coordinate system and the sensor coordinate system;
use sensor data received after the vehicle has started to move and the rotation matrix to convert sensor data to movement data of the vehicle; and
analyze the converted sensor data to determine whether the sensor data indicates existence of at least one of physical movement maneuvers of the vehicle or road surface quality by examining whether the sensor data indicates rotation around a vehicle axis.

34. The apparatus according to claim 32, wherein the at least one memory and the computer program code are further configured to, with the at least one processor, cause the apparatus:
use the determined physical movement maneuvers to identify the maneuver and a duration of the maneuver.

35. The apparatus according to claim 34, wherein the at least one memory and the computer program code are further configured to, with the at least one processor, cause the apparatus to determine one or more of the following physical maneuvers:
when the vehicle change a lane of a road:
when the vehicle is accelerating;
when the vehicle is braking;
when the vehicle is turning;
what kind of attitude of the driver of the vehicle has.

36. The apparatus according to claim 30, wherein the motion sensors are attached with a register plate of the vehicle.

37. The apparatus according to claim 30, wherein the at least one memory and the computer program code are further configured to, with the at least one processor, cause the apparatus to:
build statistics from the series of rotation data;
store the gravity vector;
derive the upward direction by combining the most common rotation vectors that roughly point towards the opposite of the stored gravity vector;
define a rotation matrix that transforms the sensor coordinate system to the vehicle coordinate system on the basis of the misalignment of the vehicle coordinate system and the sensor coordinate system;
use sensor data received after the vehicle has started to move and the rotation matrix to convert sensor data to movement data of the vehicle; and
analyze the converted sensor data to determine whether the sensor data indicates existence of at least one of physical movement maneuvers of the vehicle or road surface quality by examining whether the sensor data indicates rotation around a vehicle axis.

38. A method, comprising:
obtaining sensor data from at least one motion sensor located on-board a vehicle, said at least one motion sensor comprising an accelerometer and a gyroscope, said motion sensor having a sensor coordinate system and said vehicle having a vehicle coordinate system, said sensor data comprising three-dimensional acceleration data from the accelerometer and three-dimensional rotation data from the gyroscope with respect to the sensor coordinate system;
sampling a series of acceleration data from the accelerometer and rotation data from the gyroscope;
obtaining a gravity vector on the basis of the series of acceleration data;
removing the gravity vector from the acceleration data to obtain linear acceleration data;
determining by analyzing the sensor data that the vehicle is in an idle state when the linear acceleration data indicates that the amount of vibrations of the vehicle is less than a threshold;
determining from the linear acceleration data and rotation data when the vehicle has left the idle state and starts moving in straight line;
when the determining indicated that the vehicle has started moving in straight line, using acceleration direction indicated by a majority of acceleration data in the series of acceleration data collected when the vehicle starts moving in a straight line as a forward direction of the vehicle;
profiling the series of rotation data into two different directions;
comparing the gravity vector with the two different directions;
selecting from the two different directions that direction which has the largest angle with respect to the gravity vector as the upward direction;
using the forward direction and upward direction to determine a rightward direction, said forward direction, upward direction and rightward direction representing the vehicle coordinate system;
detecting misalignment of the sensor coordinate system and the vehicle coordinate system on the basis of the forward direction, upward direction and the rightward direction represented in the sensor coordinate system; and
determining the orientation of the motion sensor with respect to the orientation of the vehicle on the basis of the misalignment of the vehicle coordinate system and the sensor coordinate system.

39. The method according to claim 38, further comprising:
building statistics from the series of rotation data;
storing the gravity vector; and
deriving the upward direction by combining the most common rotation vectors that roughly point towards the opposite of the stored gravity vector.

40. The method according to claim 38, further comprising:
determining by analyzing motion sensor data that the vehicle is in an idle state when sensor data indicates that no vibrations of the vehicle has been detected; and
determining by analyzing motion sensor data that the vehicle is moving when sensor data indicates vibrations of the vehicle.

41. The method according to claim 38, further comprising:
defining a rotation matrix that transforms the sensor coordinate system to the vehicle coordinate system on the basis of the misalignment of the vehicle coordinate system and the sensor coordinate system;
using sensor data received after the vehicle has started to move and the rotation matrix to convert sensor data to movement data of the vehicle; and
analyzing the converted sensor data to determine whether the sensor data indicates existence of at least one of physical movement maneuvers of the vehicle and road surface quality by examining whether the sensor data indicates rotation around a vehicle axis.

42. The method according to claim 41, further comprising:
using the determined physical movement maneuvers to detect an event and a duration of the event, wherein the detected event is one or more of motion primitive, maneuver or an impact of road surface quality to the vehicle.

43. The method according to claim 42, further comprising at least one of:
detecting when the vehicle changes a lane of a road:
detecting when the vehicle is accelerating;
detecting when the vehicle is braking;
detecting when the vehicle is turning;
determining what kind of attitude the driver of the vehicle has.

44. The method according to claim 38, wherein the motion sensors are attached with a register plate of the vehicle, the method comprising obtaining the sensor data from the motion sensors attached with the register plate of the vehicle.

45. A system, comprising:
an apparatus located on-board a vehicle, said apparatus having a sensor coordinate system and said vehicle having a vehicle coordinate system, the apparatus comprising an accelerometer for generating three-dimensional acceleration data and a gyroscope for generating three-dimensional rotation data from movements of the vehicle, said acceleration data and rotation data representing sensor data;
a motion transformation appliance element configured to:
sample a series of acceleration data from the accelerometer and rotation data from the gyroscope;
obtain a gravity vector on the basis of the series of acceleration data;
determine from the acceleration data and rotation data when the vehicle starts moving in straight line;
when the determining indicated that the vehicle has started moving in straight line, use acceleration direction indicated by a majority of acceleration data in the series of acceleration data as a forward direction of the vehicle;
determine from the series of rotation data when the vehicle changes direction, the rotation data indicating at least two different directions;
compare the gravity vector with the two different directions;
select from the at least two different directions that direction which has larger angle with respect to the gravity vector as the upward direction;
use the forward direction and upward direction to determine a rightward direction, said forward direction, upward direction and rightward direction representing the vehicle coordinate system; and
determine the orientation of the apparatus with respect to the orientation of the vehicle on the basis of misalignment of the vehicle coordinate system and the sensor coordinate system.

46. The system according to claim 45, said motion transformation appliance element further configured to:
define a rotation matrix from the sensor coordinate system and the vehicle coordinate system; and
use sensor data received after the vehicle has started to move and the rotation matrix to convert sensor data to movement data of the vehicle.

47. The system according to claim 46, further comprising:
a motion analytics appliance element configured to:
use converted sensor data to determine at least one of movement maneuvers of the vehicle and road surface quality

48. The system according to claim 45, wherein said motion transformation appliance element and motion analytics appliance element are in a mobile communication device, or said motion transformation appliance element is in a mobile communication device and said motion analytics appliance element is in a network element, or said motion transformation appliance element and motion analytics appliance element are in a network element.

49. A computer program embodied on a non-transitory computer-readable medium, said computer program comprising one or more sequences of one or more instructions which, when executed by one or more processors, cause an apparatus to:
obtain sensor data from at least one motion sensor located on-board a vehicle, said at least one motion sensor comprising an accelerometer and a gyroscope, said motion sensor having a sensor coordinate system and said vehicle having a vehicle coordinate system, said sensor data comprising three-dimensional acceleration data from the accelerometer and three-dimensional rotation data from the gyroscope with respect to the sensor coordinate system;
sample a series of acceleration data from the accelerometer and rotation data from the gyroscope;
obtain a gravity vector on the basis of the series of acceleration data;
remove the gravity vector from the acceleration data to obtain linear acceleration data;
determine by analyzing the sensor data that the vehicle is in an idle state when the linear acceleration data indicates that the amount of vibrations of the vehicle is less than a threshold;
determine from the linear acceleration data and rotation data when the vehicle has left the idle state and starts moving in straight line;
when the determining indicates that the vehicle has started moving in straight line, use acceleration direction indicated by a majority of acceleration data in the series of acceleration data collected when the vehicle starts moving in a straight line as a forward direction of the vehicle;
profile the series of rotation data into two different directions;
compare the gravity vector with the two different directions;
select from the two different directions that direction which has the largest angle with respect to the gravity vector as the upward direction;
use the forward direction and upward direction to determine a rightward direction, said forward direction, upward direction and rightward direction representing the vehicle coordinate system;
detect misalignment of the sensor coordinate system and the vehicle coordinate system on the basis of the forward direction, upward direction and the rightward direction represented in the sensor coordinate system; and
determine the orientation of the motion sensor with respect to the orientation of the vehicle on the basis of the misalignment of the vehicle coordinate system and the sensor coordinate system.
